(19) United States
(12) Patent Application Publication
(10) Pub. No.: US 2023/0371520 A1
(43) Pub. Date: Nov. 23, 2023

(54) Antimicrobial Polymer Composite

(71) Applicants: TE Connectivity Solutions GmbH, Schaffhausen (CH); Tyco Electronics UK Ltd., Swindon (GB)

(72) Inventors: Lei WANG, San Jose, CA (US); Yiliang WU, San Ramon, CA (US); Ting GAO, Palo Alto, CA (US); Kaylie Jane SMITH, Oxford (GB); Chun Kwan Tsang, Newark, CA (US)

(73) Assignees: TE Connectivity Solutions GmbH, Schaffhausen (CH); Tyco Electronics UK Ltd, Swindon (GB)

(21) Appl. No.: 17/750,760

(22) Filed: May 23, 2022

(51) Int. Cl. A01N 59/20; A01N 25/10; A01N 59/16; A01N 33/12; A01P 1/00; A01N 25/34

(52) U.S. Cl. CPC A01N 59/20; A01N 25/10; A01N 59/16; A01N 33/12; A01P 1/00; A01N 25/34

(57) ABSTRACT

An antimicrobial polymer composite is described. The antimicrobial polymer composite comprises a polymer, at least one antimicrobial additive, at least one flame retardant and at least one hydrophobic additive. An apparatus formed from an antimicrobial polymer composite is also described.

### FIELD OF THE INVENTION

The present invention is directed to an antimicrobial polymer composite. The composite comprises a base polymer, an antimicrobial additive, an flame retardant and an hydrophobic additive

### BACKGROUND OF THE INVENTION

Antimicrobials are chemical compounds that reduce and/or mitigate the growth or development of microbial organisms. Antimicrobial additives work by a variety of mechanisms dependent upon the mode of action, composition, degree of activity, and application. When used properly, antimicrobial compounds lead to the death or arrested growth of the targeted microorganisms. Since their discovery in the early 1900s, antimicrobials have transformed the prevention and treatment of infectious diseases. Antimicrobial additives are currently used across a very wide array of applications, including the use of antimicrobials in the polymeric materials used in various consumer products, packaging materials, medical applications and any other application or article in which human contact is experienced. For example, polymeric materials that include antimicrobial additives can be used to make articles and devices that will then eliminate, reduce and/or mitigate the growth or development of microbial organisms.

However, antimicrobials may also be hazardous to human health. Therefore, there is a need for antimicrobial additives that do not leach out of the materials in which they are used. Further there is a need for antimicrobial additives which do not leach out of the materials in which they are used and which remain effective over the life of usage of the material, or the article or device made from the material in which the antimicrobial additive is used.

Ideally, the antimicrobial agents that provide these non-leaching antimicrobial properties would have a proven history of use and effective activity against various microorganisms without any adverse effect on person using the product. The antimicrobial material, or other materials containing the antimicrobial additive, should be applicable to products and/or surfaces thereof by commercially-viable manufacturing methods such as molding, extrusion, and all other methods of processing polymeric materials. In addition, the antimicrobial additive should not interfere with the physiochemical, electrical and/or mechanical properties of the treated material, product and/or surface there.

One approach to reduce microbial contamination is to develop surfaces with bactericidal activity, for example by making or coating the surface with a material that will release antimicrobial compounds. Almost all treatments fall into one of the following three categories: 1) adsorption of the antimicrobial additive into the surface of materials passively or in combination with surfactants or by way of surface-bonded polymers; 2) incorporation of the antimicrobial additive into a polymer coating applied on the material surface; 3) compounding the antimicrobial additive into the bulk material comprising the device.

However, all of these approaches the antimicrobial additive can leach or migrate out of the material in which it has been added. This means the antimicrobial performance of the material is generally dependent on the concentration of the antimicrobial additive (loading) and the rate of its release from the material to which it has been added. It is often very difficult to control the release rate and maintain a constant level of concentration at the surface as the release rate depends on many factors such as actual concentration, solubility, and diffusivity of these active ingredients in the bulk polymer which may also change over the time of use. All of these issues mean approaches based on this leaching mechanism are often ineffective.

Japanese Patent Publication No. 2002103572A describes a three layered polystyrene heat-shrinkable film with antibacterial properties. An antibacterial agent such as silver is used in one of the two outer layers to impart antibacterial properties to the three layered film. The antibacterial agent is used in an amount of 0.05 to 1.0 party by weight based upon 100 parts by weight of the polystyrene resin composition making up the two outer layers. The Publication also describes a method for producing the three layered film.

The article, “Antimicrobial Polyethylene through Melt Compounding with Quaternary Ammonium Salts” published in the International Journal of Polymer Science, in January, 2017, discloses the use of quaternary ammonium salt compounded with polyethylene. The authors observed leaching of samples containing biquats. No leaching was observed with monoquats.

U.S. Patent Publication No. 2006/0088678 A1 describes a dual ovenable film having a first layer comprising one or more polyamides and a second layer including one or more polyamides. The one or more layers may include one or more additives useful in packaging films, such as, antiblocking agents, slip agents, antifog agents, colorants, pigments, dyes, flavorants, antimicrobial agents, meat preservatives, antioxidants, fillers, radiation stabilizers, and antistatic agents. Such additives, and their effective amounts, are known in the art.

U.S. Patent Publication No. 2011/0081530 A1 describes a method of manufacturing of an antimicrobial polymeric film. The method comprises coextruding a polymeric substrate layer comprising a first layer of a first polymeric material and a second layer of a second polymeric material wherein the crystalline melt temperature of the second polymeric material is lower than the crystalline melting temperature of the first polymeric material. The coextruded substrate is stretched in a first direction. A polymeric second layer comprising a particulate antimicrobial and liquid vehicles are disposed on the substrate. The stretched film is then heat set. By applying the particulate antimicrobial compound to the coextruded film, it was found that greater antimicrobial activity was obtained.

U.S. Patent Publication No. 2011/022321 A1 describes a nanotextured super hydrophobic coating that contains bioactive agents, such as antimicrobials. With the release of the bioactive agent from the coating, reduction of or elimination of bacteria is accomplished.

U.S. Patent Publication No. 2021/0269656 A1 describes an antifouling polymer composite. The composite reduces or eliminates the attachment of biological materials organic materials such as bacteria. The composite comprises a polyurethane polymer and a polysiloxane polymer.

U.S. Pat. No. 9,918,466 B2 describes an antimicrobial polymer. The polymer can be produced by the incorporation of an antimicrobial ingredient into the polymer by grafting, copolymerization, or via a combined antimicrobial/plasticizer ingredient. The polymer may be produced as a masterbatch, or a ready to process polymer for producing antimicrobial products. The reactions may be conducted in a reactive extruder to provide a single-step synthesis. Some examples of antimicrobial ingredients that may be bonded include, but are not limited to quaternary ammonium salts, quaternary phosphonium salts, chlorhexidine derivatives, polyhexamethylene biguanide derivatives, povidone iodine, starch-iodine derivatives, and combinations thereof.

U.S. Pat. No. 10,051,867 B2 describes antimicrobial polymer concentrates and compounds. The patent describes antimicrobial masterbatches using migratory assisting agents to improve antimicrobial efficiency. Migratory assisting agents function by carrying the antimicrobial agent while the migratory assisting agent transfers or migrates to the surface of the polymer compound or article. As a result, antimicrobial agents are brought to the surface where there is exposure to bacterial contamination. Antimicrobial agents which can be used are chlorhexidine, chlorhexidine gluconate, glutaral, halazone, hexachlorophene, nitrofurazone, nitromersol, povidone-iodine, thimerosol, parabens, hypochlorite salts, clofucarban, clorophene, poloxamer-iodine, phenolics, mafenide acetate, aminacrine hydrochloride, quaternary ammonium salts, oxychlorosene, metabromsalan, merbromin, dibromsalan, glyceryl laurate, sodium and/or zinc pyrithione, (dodecyl) (diethylenediamine) glycine and/or (dodecyl) (aminopropyl) glycine; phenolic compounds, polymeric guanidines, quaternary ammonium salts, polymyxins, bacitracin, circulin, the octapeptins, lysozmye, lysostaphin, cellulytic enzymes generally, vancomycin, ristocetin, actinoidins, avoparcins, tyrocidin A, gramicidin S, polyoxin D, tunicamycin, neomycin, and streptomycin. Migratory assisting agents are any agents that blooms to the surface.

U.S. Pat. No. 11,267,930 B2 describes a process of making an antimicrobial polymer composition. The process comprises mixing an antimicrobial additive into a polymeric material. The polymeric material comprises a polymeric backbone made up of a urethane linkage derived from a polyisocyanate and a polyol. The mixing occurs under conditions that result in the breaking of a minority of the urethane bonds resulting in reactive isocyanate groups. The reactive isocyanate groups react with react with the antimicrobial additive to covalently bond the additive into the polymer backbone resulting in an antimicrobial polymer composition.

It would, therefore, be beneficial to provide an antimicrobial polymer composite which eliminates the problems described above. In particular, it would be beneficial to provide an antimicrobial polymer composite which comprises of a polymer, at least one antimicrobial additive, at least one flame retardant and at least one hydrophobic additive.

### SUMMARY OF THE INVENTION

An embodiment is directed an antimicrobial polymer composite comprising a polymer, at least one antimicrobial additive, at least one flame retardant, and at least one hydrophobic additive.

An embodiment is directed to an antimicrobial polymer composite comprising a mixture of polymers selected from the group comprising polyolefins, ethylene-vinyl-acetate, polyesters, ethylene-vinyl-acetate, polyesters, ethylene methyl acrylates and polyamides, at least one flame retardant, at least one antimicrobial additive and at least one hydrophobic additive.

Another embodiment is directed to an apparatus formed from a antimicrobial composite comprising a polymer, at least one antimicrobial additive, at least one flame retardant and at least one hydrophobic additive.

Other features and advantages of the present invention will be apparent from the following more detailed description of the illustrative embodiment, which illustrates, by way of example, the principles of the invention.

### DETAILED DESCRIPTION OF THE INVENTION

In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

The invention is directed to antimicrobial polymer composite having improved properties. The antimicrobial polymer composite not only prevents the adherence of bacteria but also ensures that any residual bacteria that can adhere to the surface of the composite is killed. This novel antimicrobial additive comprises a polymer, at least one antimicrobial additive, at least one flame retardant and at least one hydrophobic additive.

As used herein, the terms “polymer” or “polymeric” refer to a material that is a homopolymer, copolymer or terpolymer of the like.

As used herein, the term “antimicrobial” means any material that kills microorganisms or inhibits their growth. Preferably antimicrobial means a greater than 3 log reduction, preferably a greater than 4 log reduction, and more preferably a greater than 5 log reduction in a population of microbes relative to a control, according to ISO22196 test standard which is a recognized method to quantify the antimicrobial activity level of an antimicrobial surface (samples are exposed to bacteria for a 24-hour period at 37 degree C. In a preferred embodiment, the term antimicrobial means a greater than 3 log reduction, preferably a greater than 4 loci reduction, and more preferably a greater than 5 log reduction in a population of microbes relative to a control, measured after 12 hours, preferably after 6 hours, more preferably after 3 hours.

As used herein, the term “antifouling” refers to a material that prevents or retards the formation of a biofilm on a surface. The antifouling material may work by preventing or reducing the adhesion of microorganisms to the surface.

As used herein, the term “composite” refers a polymer matrix containing at least one polymer and various additives.

The antimicrobial polymer composite includes a polymer, which is used as a matrix for the other ingredients in the composite. Non-limiting examples of polymers that may be used in the composite include polyolefins, polyamides, polyesters, poly (meth acrylates, polycarbonates, polyvinyl alcohols, polynitriles, polyacetals, polyimides, polyarylketones, polyetherketones, polyhydroxyalkanoates, polycaprolactones, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

Many commercial species of these categories of polymers exist that can be used as the polymer of the antimicrobial polymer composite. Non-limiting examples of specific commercial polymers include acrylonitrile butadiene styrene (ABS), polymethyl methacrylate (PMMA), cellulose acetate, cyclic olefin copolymer (COC), ethylene-vinyl acetate (EVA), ethylene vinyl alcohol (EVOH), polytetrafluoroethane (PTFE), ionomers, polyoxymethylene (POM or Acetal), polyacrylonitrile (PAN), polyamide 6, polyamide 6,6, polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxybutyrate (PHB), polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene oxide (PPO), polyphenylene sulfide (PPS), polyphthalarnide (PPA), polypropylene (PP), polysulfone (PSU), polytrimethylene terephthalate (PTT), polyurethane (PU), polyvinyl acetate (PVA), ethylene methyl acrylate (EMA) and styrene-acrylonitrile (SAN).

The antimicrobial polymer composite includes at least one antimicrobial additive. Antimicrobial additives can be either inorganic antimicrobial additives or organic antimicrobial additives.

Inorganic antimicrobial additives are inorganic compounds which contain a metal or metal ions, such as silver, zinc, gold, platinum, tin, nickel, iron, palladium, copper or compounds containing silver, zinc, gold, platinum, palladium, tin, nickel or copper and the like which have antimicrobial properties. The metal-containing species may be supported on an inorganic substance such as silica or like metal oxides, zeolite, synthetic zeolite, metal bonded zeolites, metal doped phosphate based glass, zirconium phosphate, calcium phosphate, calcium zinc phosphate, ceramics, soluble glass powders, alumina silicone, titanium zeolite, apatite, calcium carbonate and the like. Other metal-containing antimicrobial compounds include mercury acetates and organozinc compounds. The inorganic antimicrobial additive, if used in the antimicrobial polymer composite, comprises about from about 0.1% by weight to about 10%, including from about 0.1% to about 8% or from about 0.5% to about 5%, by weight of the composition of the antimicrobial polymer composite.

Organic antimicrobials are organic or organometalic compounds such as quaternary ammonium salts, phenols, alcohols, aldehydes, iodophores, poly quats (such as oligermeric poly quats derivatized from an ethylenically unsaturated diamine and an ethylenically unsaturated dihalo compound), biguanides, benzoates, parabens, sorbates, propionates, imidazolidinyl urea, 1-(3-chloroallyl)-3,5,7-triaza-1-azoniaadamantane chloride (Dowacil 200, Quaternium), isothiazolones, DMDM hydantoin (2,3-imidazolidinedione), phenoxyethanol, bronopol, fluoroquinolones (such as ciprofloxacin), “potent” beta-lactams (third and fourth generation cephalosporins, carbapenems), beta-lactam/beta-lactamase inhibitors, glycopeptides, aminoglycosides, antibiotic drugs, heparin, phosphorylcholine compounds, sulfobetaine, carboxybetaine, and organometallic compounds/complexes containing silver, zinc, gold, palladium, platinum and copper. Additional examples of these organic antimicrobial agents include 3-iodo-2-propynl-n-butylcarbamate, n-butyl-1,2-benzisothiazolin-3-one,pyrithione salts, and pharmaceutical drugs such as penicillin, trichlosan, functional biguanides, mono-functional polyquaterniums, quaternized mono-functional polyvinylpyrrolidones (PVP), silane quaternary ammonium compounds, and other quaternized ammonium salts. If an organic antimicrobial additive is used in the antimicrobial polymer composite, it comprises about from about 0.1% to about 10%, including from about 0.1% to about 8% or from about 0.5% to about 5%, by weight of the composition of antimicrobial polymer composite.

In addition to the at least one antimicrobial additive, the antimicrobial polymer composite includes at least one hydrophobic additive. A hydrophobic additive is an additive that repels water. When used in the antimicrobial polymer composite, it causes any water on the surface of the antimicrobial polymer composite to bead. In addition, it is preferred that the hydrophobic additive can migrate to the surface of the antimicrobial polymer composite. The hydrophobic additive generally has a lower surface energy than the polymer matrix and can migrate to the surface. If the hydrophobic additive is able to migrate to the surface of the antimicrobial polymer composite, it is believed that less of the antimicrobial additive may be needed to obtain the desired beneficial properties of the antimicrobial polymer composite. The hydrophobic additive increases the anti-fouling and anti-dusting performance of any product made from the antimicrobial polymer composite.

The hydrophobic additive can be any hydrophobic additive, or precursor(s) of said hydrophobic additive. Examples of suitable hydrophobic polymeric additives are the polymers with surface advancing contact angle of water above 80 degrees, such as for example, but not limited to polyamide 11, polyvinylidene fluoride, and polyvinyl fluoride. Preferably the additive is a polymer with surface advancing contact angle of water above 90 degrees, such as for example, but not limited to polyethylene, polychlorotrifluoroethylene, polydimethylsiloxane, fluorinated ethylene propylene polymer, poly(tetrafluoroethylene). Examples of other hydrophobic additives that can be used, but are not limited to, hydrocarbon waxes such as paraffin wax, stearic acid, sodium octadecane-1-sulphonate, and trimethylstearylammonium chloride; fluorinated waxes such as but not limited to dialkyl amide perfluoropolyether derivatives, and hydrocarbon silicone waxes. An example of a hydrocarbon silicone wax is a triblock copolymer of ethylene and polydimethylsiloxane. Additional hydrophobic additives can also include, but are not limited to, fluoroalkylsilanes, polysiloxaes, fluorinated chemical and silane modified powders.

It may be advantageous to select a more hydrophobic additive, i.e. having a greater contact angle of water on a flat, unstructured, surface, e.g. from 80 to 140°, preferably 90 to 140°. The amount of the hydrophobic additive is in the range of from about 0.1% to about 10%, including from about 0.1% to about 8% or from about 0.5% to about 5% by weight of the entire antimicrobial composite.

The flame retardant in the antimicrobial polymer composite can be a non-halogenated phosphorus flame retardant; a halogenated flame retardant or an inorganic metal based flame retardant. Examples of non-halogenated phosphorus flame retardants include metal phosphinate salts, a metal diphosphinate salt, melamine cyanurate, melamine phosphate compounds, piperazine pyrophosphate, ammonium polyphosphates, red phosphorus, phosphate esters or combinations thereof. Inorganic metal based flame retardants include magnesium hydroxide, aluminum trihydroxide and zinc borate. Examples of halogenated flame retardants include polybrominated diphenyl ethers, deabromodiphenyl ethers or decabromodiphenyl ethane. If used in the composition, the flame retardant makes up from about 0.5% to about 50% by weight of the entire antimicrobial composite, including from about 5% to about 40%, or from about 10% to about 35% by weight of the entire antimicrobial composite.

The antimicrobial polymer composite may include additional additives conventionally employed in the manufacture of products made from polymers. Suitable additives include pigments, dyes, voiding agents, antistatic agents, foaming agents, plasticizers, radical scavengers, anti-blocking agents, anti-dust agents, antifouling agents, surface active agents, slip aids, optical brighteners, plasticizers, viscosity modifiers, gloss improvers, dispersion stabilizers, UV stabilizers, UV absorbers, antioxidants, lubricity agents, heat stabilizers, hydrolysis stabilizers, cross-linking activators, layered silicates, radio opacifiers, such as barium sulfate, tungsten metal, non-oxide bismuth salts, fillers, colorants, reinforcing agents, adhesion mediators, impact strength modifiers, antimicrobials, and any combination thereof. Such additives may be included in conventional amounts. Preferably, these additional additives are generally in the range of about 0.5% to about 50%, including from about 0.5% to about 40%, or from about 1% to about 30% by weight of the composition of the antimicrobial polymer composite. These can be mixed into the antimicrobial polymer composite in any conventional manner desired, to achieve the desired properties in the antimicrobial polymer composite.

In another aspect, the invention relates to a process for preparing the antimicrobial polymer composite. The process comprises providing a polymer, providing at least one antimicrobial additive, at least one flame retardant and at least one hydrophobic additive. The polymer, flame retardant, antimicrobial additive and the hydrophobic additive are mixed together in particulate form using any conventional process to mix materials together. The mixing equipment can be any suitable equipment in the art of mixing concentrated solids. Examples of such suitable equipment include high speed Henschel mixers, ribbon blenders, shakers, extruders and the like. Alternatively, the polymer, the antimicrobial additive and the hydrophobic additive can be heated so that they melt and then mixed together by melt compounding.

The mixing produces the desired extrudable antimicrobial polymer composite which is suitable for melt extrusion to form pellets, films, fibers, shaped products, coextrusions, profile shapes, sheets and other products conventionally produced by employing an extrusion step. When desired, the extruded composition can be pellets, shaped products, profile shapes or other products which are later extruded (or re-extruded), blow molded, thermoformed, injection molded or otherwise processed to form final desired products or apparatus.

Once the antimicrobial polymer composite is formed, the antimicrobial polymer composite can be formed into various shaped products as described above, if desired. The product may be subject to crosslinking, especially if the product is a heat shrinkable product. A crosslinker is an agent or substance that enables crosslinking in the antimicrobial polymer composite. The product of the invention can be optionally crosslinked through exposure to an agent such as heat, UV light, electron beam, or gamma-radiation with or without additional crosslinking agents or substances. If radiation is used as the crosslinker, the product is exposed to radiation in the range of 50 KGy to 1100 KGy, preferably 50 to 300 KGy to obtain the desired cross-linking. Other crosslinking substances can be chemicals, monomers or polymers having more than one homo- or hetero-functional group, capable of linking two or more binder polymer strands, two or more particles and capable of linking polymer strands and particles to each other and to the surface. In some embodiments of the present invention, the crosslinker has more than one radical generating moiety, such as aryl ketone, azide, peroxide, diazo, carbene or nitrene generator. In other embodiments, the crosslinker has more than one reactive group such as vinyl, carboxy, ester, epoxy, hydroxyl, amido, amino, thio, N-hydroxy succinimide, isocyanate, anhydride, azide, aldehyde, cyanuryl chloride or phosphine that can thermochemically react with functionalized binder polymer. In addition, the product of the instant invention can be crosslinked using radical generators. Radicals generators can form new bonds through radical-radical combination, addition to unsaturated bonds, hydrogen abstraction and subsequent recombination, as well as possible electron transfer reactions. Examples of radical initiators include benzophenone, acetophenone derivatives, peroxyides, peroxy compounds, benzoin derivatives, benzilketals, hydroxyalkylphenones and aminoalkylphenones, O-acyl oximoketones, acylphosphin oxides and acylphosphonates, thiobenzoic S-esters, azo and azide compounds, triazines, 1,2 diketones, quinones, coumarins, xanthones. The antimicrobial polymer composite is crosslinked to preferably obtain a crosslinking density of about 40 to about 150 psi depending upon the desired final product.

The crosslinked polymer antimicrobial polymer composite can be further processed or formed into any desired shape, such as a sheets, pipes, profiles using standard manufacturing techniques for these products.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. An antimicrobial polymer composite comprising a mixture of a polymer, at least one flame retardant, at least one antimicrobial additive and at least one hydrophobic additive.

2. The antimicrobial polymer composite of claim 1, wherein the polymer is chosen from the group consisting essentially of: include polyolefins, polyamides, polyesters, poly (meth)acrylates, polycarbonates, polyvinyl alcohols, polynitriles, polyacetals, polyimides, polyarylketones, polyetherketones, polyhydroxyalkanoates, polycaprolactones, polyurethanes, polysulfones, polyphenylene oxides, polyphenylene sulfides, polyacetates, liquid crystal polymers, fluoropolymers, ionomeric polymers, thermoplastic elastomers, and copolymers of any of them and combinations of any two or more of them.

3. The antimicrobial polymer composite of claim 1, wherein the antimicrobial polymer composite has a 3 log reduction of bacteria as measured using ISO 22196 test standard.

4. The antimicrobial polymer composite of claim 1, wherein said antimicrobial additive is an inorganic antimicrobial additive chosen from the group consisting essentially of: silver, zinc, gold, platinum, palladium, tin, nickel, iron, or copper or compounds containing silver, zinc, gold, platinum, palladium, tin, nickel or copper or metal doped phosphate-based glasses or metal loaded zeolites.

5. The antimicrobial polymer composite of claim 1, wherein said antimicrobial additive is an organic antimicrobial additive chosen from the group consisting essentially of: quaternary ammonium salts, phenols, alcohols, aldehydes, iodophores, poly quats (such as oligermeric poly quats derivatized from an ethylenically unsaturated diamine and an ethylenically unsaturated dihalo compound), biguanides, benzoates, parabens, sorbates, propionates, imidazolidinyl urea, 1-(3-chloroallyl)-3,5,7-triaza-1-azoniaadamantane chloride (Dowacil 200, Quaternium), isothiazolones, 3-iodo-2-propynyl-n-butylcarbamate, n-butyl-1,2-benzisothiazolin-3-one, DMDM hydantoin (2,3-imidazolidinedione), phenoxyethanol, bronopol, fluoroquinolones, beta-lactams, beta-lactam/beta-lactamase inhibitors, glycopeptides, aminoglycosides, antibiotic drugs, heparin, phosphorylcholine compounds, sulfobetaine, carboxybetaine, and organometallic compounds/complexes containing silver, zinc, palladium, platinum, gold and copper.

6. The antimicrobial polymer composite of claim 1, wherein said at least one hydrophobic additive is chosen from the group consisting essentially of polyamide 11, polyvinylidene fluoride, polyvinyl fluoride, polyethylene, polychlorotrifluoroethylene, polydimethylsiloxane, fluorinated ethylene propylene polymer, poly(tetrafluoroethylene), paraffin wax, stearic acid, sodium octadecane-1-sulphonate, trimethylstearylammonium chloride, dialkyl amide perfluoropolyether derivatives, and hydrocarbon silicone waxes, fluoroalkylsilanes, polysiloxaes, fluorinated chemical and silane modified powders, hydrophobic polyesters, hydrophobic polyamides, hydrophobic polyurethanes, fluoropolymers, polyolefins, hydrophobic vinyl polymers, hydrophobic silicones, silicone rubbers, polysiloxanes, hydrocarbon waxes, fluorinated waxes, hydrocarbon silicone waxes, fluoroalkylsilanes, poly(tetrafluoroethylene) (PTFE) and silicone elastomers.

7. The antimicrobial polymer composite of claim 1, wherein said flame retardant is selected from the group consisting essentially of non-halogenated phosphorous flame retardants, inorganic metal-based flame retardants, or halogenated flame retardants.

8. The antimicrobial polymer composite of claim 1, wherein said antimicrobial polymer composite further comprises a crosslinker.

9. The antimicrobial polymer composition of claim 8, wherein said crosslinker is chosen from the group consisting of heat, ultraviolet light, radiation crosslinking, gamma radiation or a chemical crosslinking substance.

10. The antimicrobial polymer composite of claim 1, wherein said antimicrobial additive is from about 0.1% by weight to about 10% by weight.

11. An apparatus made from the antimicrobial polymer composite of claim 1.

12. The apparatus of claim 11, wherein said apparatus is a heat-shrinkable tube or heat-shrinkable molded part.

13. An antimicrobial polymer composite comprising a mixture of polymers selected from the group comprising polyolefins, ethylene-vinyl-acetate, polyesters, ethylene methyl acrylate, and polyamides, at least one flame retardant, at least one antimicrobial additive and at least one hydrophobic additive.

14. The antimicrobial polymer composite of claim 13, wherein said flame retardant is selected from the group consisting essentially of non-halogenated phosphorous flame retardants, inorganic metal-based flame retardants, or halogenated flame retardants.

15. The antimicrobial polymer composite of claim 13, wherein said at least one hydrophobic additive is selected from the group consisting essentially of polyamide 11, polyvinylidene fluoride, polyvinyl fluoride, polyethylene, polychlorotrifluoroethylene, polydimethylsiloxane, fluorinated ethylene propylene polymer, poly(tetrafluoroethylene), paraffin wax, stearic acid, sodium octadecane-1-sulphonate, trimethylstearylammonium chloride, dialkyl amide perfluoropolyether derivatives, and hydrocarbon silicone waxes, fluoroalkylsilanes, polysiloxaes, fluorinated chemical and silane modified powders, hydrophobic polyesters, hydrophobic polyamides, hydrophobic polyurethanes, fluoropolymers, polyolefins, hydrophobic vinyl polymers, hydrophobic silicones, silicone rubbers, polysiloxanes, hydrocarbon waxes, fluorinated waxes, hydrocarbon silicone waxes, fluoroalkylsilanes, poly(tetrafluoroethylene) (PTFE) and silicone elastomers.

16. The antimicrobial polymer composite of claim 13, wherein said at least one antimicrobial additive is an organic antimicrobial additive or an inorganic antimicrobial additive.

17. The antimicrobial polymer composite of claim 16, wherein said wherein said inorganic antimicrobial additive is chosen from the group consisting essentially of: silver, zinc, gold, platinum, palladium, tin, nickel, iron, or copper or compounds containing silver, zinc, gold, platinum, palladium, tin, nickel or copper or metal doped phosphate-based glasses or metal loaded zeolites.

18. The antimicrobial polymer composite of claim 16, wherein said organic antimicrobial additive is chosen from the group consisting essentially of quaternary
